(19) United States
(12) Patent Application Publication
(10) Pub. No.: US 2011/0292636 A1
(43) Pub. Date: Dec. 1, 2011

(54) LIGHT EMITTING DEVICE AND ILLUMINATION DEVICE

(75) Inventors: Yasuo FUKAI, Osaka-shi (JP); Hidenori Kawanishi, Osaka-shi (JP)

(73) Assignee: SHARP KABUSHIKI KAISHA, Osaka-shi (JP)

(21) Appl. No.: 13/115,738

(22) Filed: May 25, 2011

(30) Foreign Application Priority Data
May 26, 2010 (JP) 2010-120794

(51) Int. Cl. F21V 9/14

(52) U.S. Cl. 362/19

(57) ABSTRACT

A light emitting device capable of improving light extraction efficiency is provided. The light emitting device includes: a laser generator which outputs linearly polarized laser light; a fluorescent body which is irradiated with the laser light from the laser generator; and a reflective polarization filter which is arranged in a region through which the laser light outputted from the laser generator passes. The reflective polarization filter is formed to transmit linearly polarized light of the laser light and reflect linearly polarized light having a polarization plane which is perpendicular to a polarization plane of the linearly polarized light of the laser light.

This application is based on Japanese Patent Application No. 2010-120794 filed on May 26, 2010, the contents of which are hereby incorporated by reference.

### BACKGROUND OF THE INVENTION

1. Field of the Invention

The present invention relates to a light emitting device and an illumination device. In particular, the present invention relates to a light emitting device and an illumination device including a laser generator and a fluorescent body.

2. Description of Related Art

Conventionally, light emitting devices including a laser generator and a fluorescent body have been known. An example of such light emitting devices is disclosed in JP-A-2003-295319.

FIG. 18 is a sectional view showing the structure of a light source device (a light emitting device) disclosed in the above-mentioned JP-A-2003-295319. The above-mentioned JP-A-2003-295319 discloses the light source device as shown in FIG. 18, which includes: an ultraviolet ray LD element (a laser generator) 1001; a collimator lens 1002, which is provided in front of the ultraviolet ray LD element 1001; an aperture 1003, which is provided in front of the collimator lens 1002; a condenser lens 1004, which is provided in front of the aperture 1003; a fluorescent body 1005, which is provided in front of the condenser lens 1004; an ultraviolet ray reflecting mirror 1006, which is provided in front of the fluorescent body 1005; and a visible light reflecting mirror 1007, which is provided such that the condenser lens 1004, the fluorescent body 1005, and the ultraviolet ray reflecting mirror 1006 are placed inside a parabolic reflecting surface of the visible light reflecting mirror 1007.

In this light source device, laser light 1010, which is coherent light outputted from the ultraviolet ray LD element 1001, is turned into a parallel pencil of rays upon passing through the collimator lens 1002. The laser light 1010, having passed through the collimator lens 1002, passes through the aperture 1003, a hole (an opening) 1007a of the visible light reflecting mirror 1007, and the condenser lens 1004, to be collected onto the fluorescent body 1005.

The laser light 1010 entering the fluorescent body 1005 causes an excitation within the fluorescent body 1005, and the laser light 1010 is absorbed within the fluorescent body 1005, so that the intensity of the laser light 1010 is reduced, and spontaneous emission light 1011a, which is incoherent light, is released in all directions from the fluorescent body 1005. Light that has not been absorbed by the fluorescent body 1005 leaks out of the fluorescent body 1005, but the light is reflected by the ultraviolet ray reflecting mirror 1006 to enter the fluorescent body 1005 again to be absorbed by the fluorescent body 1005, and the spontaneous emission light 1011a is released in all directions.

The spontaneous emission light 1011a, which is incoherent light spontaneously released from the fluorescent body 1005, is reflected by the visible light reflecting mirror 1007, and turned into a parallel pencil of rays 1011b, which travels in a predetermined direction.

Here, “coherent light” is light of high coherence, which is uniform in temporal and spatial phases.

With the above-described light source device (the light emitting device) of JP-A-2003-295319, however, since the spontaneous emission light 1011a is released in all directions from the fluorescent body 1005, part of the spontaneous emission light 1011a passes through the hole (the opening) 1007a of the visible light reflecting mirror 1007 to return (escape) to the ultraviolet ray LD element 1001 side. This makes it disadvantageously difficult to improve the light extraction efficiency (light utilization efficiency).

### SUMMARY OF THE INVENTION

The present invention has been made to solve the above problem, and an object of the present invention is to provide a light emitting device and an illumination device capable of improving the light extraction efficiency.

To achieve the above object, according to a first aspect of the present invention, a light emitting device includes: a laser generator which outputs linearly polarized laser light; a fluorescent body which is irradiated with the laser light from the laser generator; and a reflective polarization filter which is arranged in a region through which the laser light outputted from the laser generator passes. Here, the reflective polarization filter is formed to transmit linearly polarized light of the laser light and reflect linearly polarized light having a polarization plane which is perpendicular to a polarization plane of the linearly polarized light of the laser light.

With the light emitting device according to the first aspect, as described above, the reflective polarization filter is arranged in the region through which the laser light outputted from the laser generator passes, and the reflective polarization filter is formed to transmit the linearly polarized light of the laser light and to reflect the linearly polarized light whose polarization plane is perpendicular to that of the linearly polarized light of the laser light. This makes it possible to reflect linearly polarized light that is included in light outputted from the fluorescent body to travel toward the laser generator side (the reflective polarization filter) and whose polarization plane is perpendicular to that of the linearly polarized light of the laser light. That is, in a case in which, for example, the laser light outputted from the laser generator is a TE (transverse electric) wave, the reflective polarization filter, which transmits a TE wave while it reflects a TM (transverse magnetic) wave, is able to reflect a TM wave component of the light that is outputted from fluorescent body to travel toward the laser generator side (the reflective polarization filter). As a result, it is possible to restrict the light that is outputted from the fluorescent body and travels toward the laser generator side (toward the reflective polarization filter) from returning (escaping) to the laser generator side, and it is also possible to reflect part (the TM wave component) of the light by the reflective polarization filter to make use of the part. As a result, it is possible to improve the light extraction efficiency (the light utilization efficiency).

The light emitting device according to the first aspect may further include a reflecting mirror which reflects light coming from the fluorescent body in a predetermined direction.

Preferably, in the above-described light emitting device including the reflecting mirror, the reflecting mirror includes an opening through which the laser light outputted from the laser generator passes, and that the reflective polarization filter is arranged to close the opening. This structure makes it possible to easily restrict the light that is outputted from the fluorescent body and passes through the opening of the reflecting mirror from returning to the laser generator side. This makes it possible to easily improve the light extraction efficiency.

Preferably, in the above-described light emitting device including the reflecting mirror, a surface of the reflective polarization filter at the fluorescent body side is arranged so as not to project from a reflecting surface of the reflecting mirror toward the fluorescent body side. With this structure, it is possible to prevent light outputted from the fluorescent body from entering the reflective polarization filter from an outer circumference surface (the side surface) of the reflective polarization filter. That is, it is possible to make all the light that enters the reflective polarization filter do so through the surface of the reflective polarization filter at the fluorescent body side. This makes it possible to restrict linearly polarized light that is included in the light outputted from the fluorescent body and whose polarization plane is perpendicular to that of the linearly polarized light of the laser light from passing through the reflective polarization filter. As a result, it is possible to restrict degradation of the light extraction efficiency. Furthermore, it is possible, when the laser light outputted from the laser generator enters the reflective polarization filter, to restrict the laser light from leaking through the outer circumference surface (the side surface) of the reflective polarization filter. This makes it possible to further restrict degradation of the light extraction efficiency.

Preferably, in the above-described light emitting device provided with the reflecting mirror, the reflecting mirror includes an opening through which the laser light outputted from the laser generator passes, and the reflective polarization filter have an area larger than the opening. This structure makes it possible to easily restrict the light that is outputted from the fluorescent body from passing through the opening of the reflecting mirror to return to the laser generator side. As a result, it is possible to easily improve the light extraction efficiency. Furthermore, the reflective polarization filter does not need to be formed to fit the diameter of the opening, and this helps facilitate the production of the reflective polarization filter.

Preferably, in the above-described reflective polarization filter in which the reflecting mirror includes the opening, the reflective polarization filter is arranged to close the opening from a side opposite to the fluorescent body. With this structure, in contrast to a case in which the reflective polarization filter is arranged to close the opening from the fluorescent body side, no part of the reflecting surface of the reflecting mirror is covered by the reflective polarization filter, and this helps restrict degradation of the light extraction efficiency.

Preferably, in the above-described light emitting device in which the reflecting mirror includes an opening, the reflective polarization filter includes a first region which is arranged to face the opening and a second region which surrounds the first region, and the second region has a photonic crystal structure. With this structure, it is possible to restrict the laser light outputted from the laser generator and the light outputted from the fluorescent body, in entering the reflective polarization filter, from entering the second region from the first region of the reflective polarization filter. This makes it possible to restrict the laser light outputted from the laser generator and the light outputted from the fluorescent body from leaking through the outer circumference surface (the side surface) of the reflective polarization filter. This makes it possible to restrict degradation of the light extraction efficiency.

Preferably, the above-described light emitting device according to the first aspect further includes an optical member which is arranged in the region through which the laser light outputted from the laser generator passes, and the reflective polarization filter is formed on a surface of the optical member. With this structure, it is possible to form the reflective polarization filter and the optical member as one piece, and this helps reduce the size and weight of the light emitting device.

In the above-described light emitting device in which the reflective polarization filter is formed on the surface of the optical member, the optical member may include at least either one of a light guide member and a lens.

In the above-described light emitting device in which the optical member includes at least either one of a light guide member and a lens, the optical member may include a light guide member having a laser light input surface and a first laser light output surface, and the reflective polarization filter may be formed on at least either one of the laser light input surface and the first laser light output surface of the light guide member.

In the above-described light emitting device in which the optical member includes at least either one of the light guide member and a lens, the optical member may include a light guide member and a lens arranged between the light guide member and the fluorescent body, and the reflective polarization filter may be formed on a surface of the lens.

Preferably, the above-described light emitting device according to the first aspect further includes a light guide member which is arranged in the region through which the laser light outputted from the laser generator passes, and the light guide member includes a laser light input surface and a second laser light output surface having an area smaller than the laser light input surface. With this structure, it is possible to collect the laser light that passes inside the light guide member. This makes it possible, for example, to collect laser light outputted from a plurality of laser generators by using the light guide member and irradiate the laser light onto a fluorescent body. As a result, it is possible to reduce the number of fluorescent bodies even in the case in which a plurality of laser generators are used, and thus it is possible to reduce the size and weight of the light emitting device.

Preferably, in the above-described light emitting device according to the first aspect, the reflective polarization filter is formed on a third laser light output surface of the laser generator. With this structure, it is possible to form the reflective polarization filter and the laser generator as one piece, and this helps reduce the size and weight of the light emitting device. Furthermore, in assembling the light emitting device, there is no need of performing angle adjustment with respect to the laser generator and the reflective polarization filter such that the reflective polarization filter transmits the linearly polarized light of the laser light outputted from the laser generator. This makes it possible to simplify the assembly procedure of the light emitting device.

Preferably, in the above-described light emitting device according to the first aspect, the fluorescent body is provided on a fourth laser light output surface of the reflective polarization filter. With this structure, it is possible to form the reflective polarization filter and the fluorescent body as one piece, and this helps reduce the size and weight of the light emitting device.

Preferably, the above-described light emitting device according to the first aspect further includes a reflecting mirror which reflects light from the fluorescent body in a predetermined direction and a light guide member which is arranged in the region through which the laser light outputted from the laser generator passes, the reflecting mirror includes an opening through which the laser light outputted from the laser generator passes, and the light guide member is fitted in the opening of the reflecting mirror. With this structure, it is possible to restrict increase in size of the opening, and thus to further restrict the light from the fluorescent body from returning to the laser generator side through the opening.

Preferably, in the light emitting device according to the first aspect described above, the laser generator includes a semiconductor laser element. The use of the semiconductor laser element as a laser light source (laser generator) in this way makes it possible to reduce the size and weight of the laser light source (laser generator), and thus to reduce the size and weight of the light emitting device.

Preferably, in the above-described light emitting device according to the first aspect, the reflective polarization filter includes a multi-layer film polarizer. With this structure, it is possible to easily form a reflective polarization filter even, for example, on a curved surface or on a small (small-area) portion.

Preferably, in the above-described light emitting device according to the first aspect, the reflective polarization filter includes a wire grid. This structure makes it easy to form the reflective polarization filter.

According to a second aspect of the present invention, an illumination device includes the above-structured light emitting device. With this structure, it is possible to obtain a light emitting device capable of improving the light extraction efficiency.

### BRIEF DESCRIPTION OF THE DRAWINGS

FIG. 1 is a sectional view showing the structure of a light emitting device according to a first embodiment of the present invention;

FIG. 2 is an enlarged view for illustrating the structure of a reflective polarization filter of the light emitting device according to the first embodiment of the present invention shown in FIG. 1;

FIG. 3 is a sectional view showing the structure of a light emitting device according to a second embodiment of the present invention;

FIG. 4 is an enlarged view for illustrating the structure of a reflective polarization filter of the light emitting device according to the second embodiment of the present invention shown in FIG. 3;

FIG. 5 is a sectional view showing the structure of a light emitting device according to a third embodiment of the present invention;

FIG. 6 is a sectional view showing the structure of a light emitting device according to a fourth embodiment of the present invention;

FIG. 7 is a front view showing the structure of a light transmitting member of the light emitting device according to the fourth embodiment of the present invention shown in FIG. 6;

FIG. 8 is an enlarged front view showing the structure of the light transmitting member of the light emitting device according to the fourth embodiment of the present invention shown in FIG. 6;

FIG. 9 is a sectional view showing the structure of a light emitting device according to a fifth embodiment of the present invention;

FIG. 10 is a sectional view showing the structure of a light emitting device according to a sixth embodiment of the present invention;

FIG. 11 is a sectional view showing the structure of a light emitting device according to a seventh embodiment of the present invention;

FIG. 12 is a sectional view showing the structure of a light emitting device according to an eighth embodiment of the present invention;

FIG. 13 is a sectional view showing the structure of a light emitting device according to a ninth embodiment of the present invention;

FIG. 14 is a plan view for illustrating the structure of a light guide member of the light emitting device according to the ninth embodiment of the present invention shown in FIG. 13;

FIG. 15 is a sectional view showing the structure of a light emitting device according to a first modified example of the present invention;

FIG. 16 is a sectional view showing the structure of a light emitting device according to a second modified example of the present invention;

FIG. 17 is a sectional view showing the structure of a light emitting device according to a third modified example of the present invention; and

FIG. 18 is a sectional view showing the structure of a light source device (a light emitting device) disclosed in the above-mentioned JP-A-2003-295319.

### DETAILED DESCRIPTION OF PREFERRED EMBODIMENTS

Embodiments of the present invention will be described below with reference to the accompanying drawings. In the sectional views, some cross-section surfaces are not indicated by hatching for ease of understanding.

### First Embodiment

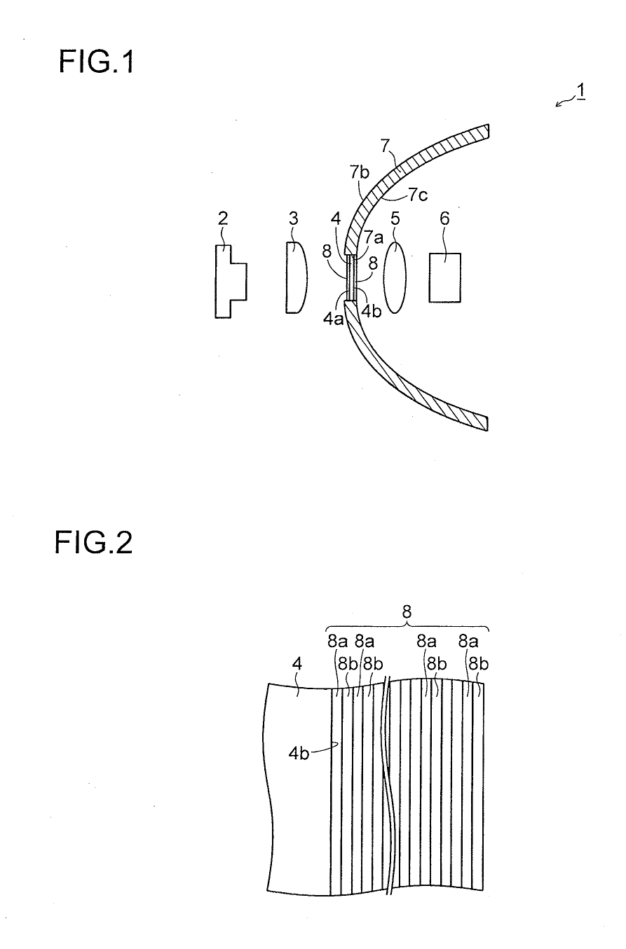

A description will be given of the structure of a light emitting device 1 of a first embodiment of the present invention with reference to FIGS. 1 and 2.

A light emitting device 1 according to the first embodiment of the present invention is usable as an illumination device such as a vehicle head lamp as well, and includes, as shown in FIG. 1, a semiconductor laser element 2, a collimator lens 3 which is arranged in front of the semiconductor laser element 2, a light transmitting member 4 which is arranged in front of the collimator lens 3, a lens 5 which is arranged in front of the light transmitting member 4, a fluorescent body 6 which is arranged in front of the lens 5, and a reflecting mirror 7. The semiconductor laser element 2, the collimator lens 3, the light transmitting member 4, the lens 5, and the fluorescent body 6 are arranged in line. Here, the semiconductor laser element 2 is an example of a “laser generator” of the present invention.

The semiconductor laser element 2, for example, outputs (oscillates) blue-violet laser light, and functions as a laser light source. The semiconductor laser element 2 outputs linearly polarized laser light. Incidentally, the laser light outputted from the semiconductor laser element 2 is coherent light.

The collimator lens 3 is formed of a planoconvex lens, for example, and has a function of transmitting laser light from the semiconductor laser element 2 and converting the laser light into parallel light that travels forward from the collimator lens 3. Incidentally, the beam-spot diameter of the laser light that has passed through the collimator lens 3 is, for example, approximately 5 mm.

The light transmitting member 4 is formed of, for example, an SiO₂ (glass) substrate having a thickness of approximately 5 mm. Incidentally, the thinner the light transmitting member 4 is, the less the propagation loss of the laser light (the amount of the laser light that is lost while passing through the light transmitting member 4) is. If the mechanical strength of a later-described reflective polarization filter 8 can be secured, the light transmitting member 4 may be omitted. In later-described second to fifth embodiments and a first modified example of the present invention as well, the light transmitting member 4 may be omitted under the condition that the mechanical strength of the reflective polarization filter 8 is secured.

The light transmitting member 4 includes a laser light input surface 4a formed at the semiconductor laser element 2 side and a laser light output surface 4b formed at a side opposite to the semiconductor laser element 2.

Here, in the first embodiment, the reflective polarization filter 8 is provided on each of the laser light input surface 4a and the laser light output surface 4b of the light transmitting member 4.

The light transmitting member 4 and the reflective polarization filters 8 are formed to have a diameter that is equal to or slightly smaller than the diameter of a later-described opening 7a of the reflecting mirror 7. The light transmitting member 4 and the reflective polarization filters 8 are fitted in the later-described opening 7a of the reflecting mirror 7 to close the opening 7a. An unillustrated adhesive or the like may be provided between the outer circumference surfaces (the side surfaces) of the light transmitting member 4 and of the reflective polarization filters 8 and the inner circumference surface of the later-described opening 7a of the reflecting mirror 7, to thereby fix the light transmitting member 4 and the reflective polarization filters 8 in the later-described opening 7a of the reflecting mirror 7.

Also, in the first embodiment, the reflective polarization filters 8 are arranged so as not to project out of the later-described opening 7a of the reflecting mirror 7. Specifically, the reflective polarization filter 8 provided on the laser light input surface 4a is arranged such that its rear surface (the outermost surface at the semiconductor laser element 2 side) does not project outward (toward the semiconductor laser element 2 side) from an exterior surface 7b of the reflecting mirror 7. The reflective polarization filter 8 provided on the laser light input surface 4b is arranged such that its front surface (the outermost surface at the side opposite to the semiconductor laser element 2) does not project inward (toward the side (the fluorescent body 6 side) opposite to the semiconductor laser element 2) from a later-described interior surface 7c of the reflecting mirror 7. Incidentally, in the first embodiment, the front surface of the reflective polarization filter 8 provided on the laser light output surface 4b is arranged such that it is flush (such that it does not form a step) with the later-described interior surface 7c of the reflecting mirror 7. The front surface of the reflective polarization filter 8 is an example of the “surface of the reflective polarization filter at the fluorescent body side” of the present invention.

In the first embodiment, the reflective polarization filters 8 are formed such that they transmit the laser light (lineally polarized light) from the semiconductor laser element 2 and reflect linearly polarized light having a polarization plane that is perpendicular to the polarization plane of the laser light. That is, assuming that the laser light outputted from the semiconductor laser element 2 is, for example, a TE wave, the reflective polarization filter 8 is formed, as will be described later, to reflect the TM wave component of light from the fluorescent body 6. Incidentally, in the present specification, for the sake of convenience, two types of linearly polarized light whose polarization planes are perpendicular to each other are referred to as a TE wave and a TM wave in the descriptions.

Specifically, in the first embodiment, as shown in FIG. 2, the reflective polarization filter 8 is formed of a multi-layer film polarizer using a dielectric material having a birefringence index, which is formed by laying fifty CaCo₃ layers 8a and fifty SiO₂ layers 8b alternately one on top of another sequentially from the light transmitting member 4 side.

The reflective polarization filters 8 are formed on the surfaces (the laser light input surface 4a and the laser light output surface 4b) of the light transmitting member 4 by using a publicly known thin-film forming method such as a vacuum deposition method and a sputtering method.

Here, CaCo₃ (CaCo₃ layers 8a) has different refractive indices for different polarization planes of linearly polarized light, and has a refractive index of approximately 1.48 for the TE wave and a refractive index of approximately 1.66 for the TM wave. SiO₂ (SiO₂ layers 8b) has a refractive index of approximately 1.45.

Assuming that a center wavelength of light to be reflected (visible light from the fluorescent body 6) is λ (for example, 510 nm) and a refractive index for the layer (the CaCo₃ layer 8a and the SiO₂ layer 8b) is n, the CaCo₃ layer 8a and the SiO₂ layer 8b are each formed to have a thickness of λ/(4n).

That is, since the refractive index of CaCo₃ for the TM wave is approximately 1.66, the thickness of the CaCo₃ layer 8a is λ/(4n)=510/(4×approximately 1.66)=approximately 76.8 nm. On the other hand, since the refractive index of SiO₂ is approximately 1.45, the thickness of the SiO₂ layer 8b is λ/(4n)=510/(4×approximately 1.45)=approximately 87.9 nm.

Incidentally, as shown in FIG. 1, the reflective polarization filter 8 on the laser light input surface 4a and the reflective polarization filter 8 on the laser light output surface 4b are formed to have structures symmetrical to each other with respect to the light transmitting member 4.

And, angle adjustment is performed with respect to the semiconductor laser element 2 and the reflective polarization filters 8 such that the reflective polarization filters 8 transmit the laser light (TE wave) from the semiconductor laser element 2 and reflect the TM wave whose polarization plane is perpendicular to that of the laser light. In other words, the semiconductor laser element 2 and the reflective polarization filters 8 are arranged such that the polarization plane of the linearly polarized light of the laser light from the semiconductor laser element 2 and the polarization plane of linearly polarized light that the reflective polarization filters 8 transmit coincide with each other.

Incidentally, in the first embodiment, the reflective polarization filter 8 is provided on each of the laser light input surface 4a and the laser light output surface 4b of the light transmitting member 4, but instead, the reflective polarization filter 8 may be provided only on the laser light input surface 4a or the laser light output surface 4b of the light transmitting member 4. However, reflectance of the reflective polarization filter 8 for the TM wave is, for example, on the order of 90%, and thus, it is more advisable to provide the reflective polarization filter 8 on each of the laser light input surface 4a and the laser light output surface 4b.

The lens 5 is formed of for example, a double-convex lens, and has a function of collecting the laser light from the semiconductor laser element 2 onto the fluorescent body 6. Incidentally, the lens 5 may be fixed to the reflecting mirror 7 by an unillustrated holding member.

The fluorescent body 6 has a function of converting the laser light from the semiconductor laser element 2 to visible light composed of, for example, blue light, green light, red light, etc. and outputting the resulting visible light. The visible light outputted from the fluorescent body 6 includes not only a TE wave component but also a TM wave component, and is outputted in every direction. Further, since the blue light, the green light, and the red light outputted from the fluorescent body 6 are mixed to generate white light, the visible light outputted to the outside is white light. The fluorescent body 6 may be fixed by an unillustrated holding member. Incidentally, the visible light outputted from the fluorescent body 6 is incoherent light.

The reflecting mirror 7 is, for example, made of metal. The reflecting mirror 7 has a thickness equal to or larger than the sum of the thicknesses of the light transmitting member 4 and the reflective polarization filters 8.

The opening 7a is formed in a middle part of the reflecting mirror 7 for the laser light from the semiconductor laser element 2 to pass through. That is, the opening 7a, the light transmitting member 4 and the reflective polarization filters 8 are arranged in the region through which the laser light outputted from the semiconductor laser element 2 passes.

The interior surface 7c of the reflecting mirror 7 is formed of a reflecting surface having a function of reflecting light from the fluorescent body 6 toward the front. The interior surface 7c is formed, for example, in a paraboloid shape. The interior surface 7c may be formed as part of an ellipsoid, or may be formed as a surface that is asymmetric in the up-down or left-right direction. The interior surface 7c is an example of the “reflecting surface” of the present invention.

In the light emitting device 1, the laser light outputted from the semiconductor laser element 2 becomes parallel light by passing through the collimator lens 3. The laser light that has passed through the collimator lens 3 passes through the light transmitting member 4 and the reflective polarization filters 8, and collected by the lens 5 to be irradiated onto the fluorescent body 6.

The laser light is converted to incoherent visible light by the fluorescent body 6 to be outputted in every direction. Most part of the visible light outputted from the fluorescent body 6 either continues to travel to the front or is reflected by the reflecting mirror 7 to travel toward the front. On the other hand, part of the visible light outputted from the fluorescent body 6 travels toward the opening 7a of the reflecting mirror 7.

In the first embodiment, the TM wave component of the visible light that travels toward the opening 7a of the reflecting mirror 7 is reflected by the reflective polarization filters 8 to be outputted toward the front.

In the first embodiment, as described above, the reflective polarization filters 8, which are arranged in the region through which the laser light outputted from the semiconductor laser element 2 passes, are formed to transmit the linearly polarized light of the laser light, and reflect linearly polarized light having a polarization plane that is perpendicular to that of the linearly polarized light of the laser light. This makes it possible to reflect the linearly polarized light having a polarization plane perpendicular to that of the linearly polarized light of the laser light and included in the light (the visible light) that travels toward the semiconductor laser element 2 side (toward the opening 7a of the reflecting mirror 7). That is, in a case in which the laser light outputted from the semiconductor laser element 2 is a TE wave, the reflective polarization filters 8, which transmit a TE wave but reflect a TM wave, are able to reflect the TM wave component of the light outputted from fluorescent body 6 and travelling toward the semiconductor laser element 2 side (toward the opening 7a of the reflecting mirror 7). As a result, it is possible to restrict light outputted from the fluorescent body 6 and travelling toward the semiconductor laser element 2 side (toward the opening 7a of the reflecting mirror 7) from passing through the opening 7a to return (escape) to the semiconductor laser element 2 side, and it is also possible to reflect part (the TM wave component) of the light by the reflective polarization filters 8 to make use of the part. As a result, it is possible to improve the light extraction efficiency (light utilization efficiency).

In the first embodiment, as described above, the reflective polarization filters 8 are arranged to close the opening 7a, to thereby make it possible to easily restrict light (visible light) that is outputted from the fluorescent body 6 from returning to the semiconductor laser element 2 side after passing through the opening 7a of the reflecting mirror 7. This makes it possible to easily improve the light extraction efficiency.

In the first embodiment, as described above, the reflective polarization filter 8 provided on the laser light output surface 4b is arranged such that its front surface (the outermost surface at the side opposite to the semiconductor laser element 2) does not project from the interior surface 7c of the reflecting mirror 7 toward the fluorescent body 6 side. This makes it possible to prevent light outputted from the fluorescent body 6 from entering the light transmitting member 4 and the reflective polarization filter 8 from their circumference surfaces (the side surfaces). That is, it is possible to make all the light that enters the reflective polarization filter 8 do so through the surface of the reflective polarization filter 8 at the fluorescent body 6 side. This makes it possible to restrict linearly polarized light included in the light outputted from the fluorescent body 6 and having a polarization plane that is perpendicular to that of the linearly polarized light of the laser light from passing through the reflective polarization filter 8. As a result, it is possible to restrict degradation of the light extraction efficiency. Furthermore, it is possible, when the laser light outputted from the semiconductor laser element 2 enters the light transmitting member 4 and the reflective polarization filter 8, to restrict the light from leaking through circumference surfaces (side surfaces) of the light transmitting member 4 and the reflective polarization filter 8. This makes it possible to further restrict degradation of the light extraction efficiency.

Likewise, the reflective polarization filter 8 provided on the laser light input surface 4a is arranged such that its rear surface (the outermost surface at the semiconductor laser element 2 side) does not project outward (toward the semiconductor laser element 2 side) from the exterior surface 7b of the reflecting mirror 7, and thereby, it is possible to restrict degradation of the light extraction efficiency.

Also, in the first embodiment, as described above, by using the semiconductor laser element 2 as a laser light source (a laser generator), it is possible to reduce the size and weight of the laser light source, and thus to reduce the size and weight of the light emitting device 1.

Further, in the first embodiment, as described above, the reflective polarization filters 8 are each formed of a multi-layer film polarizer, and this makes it possible to form the reflective polarization filters 8 easily.

### Second Embodiment

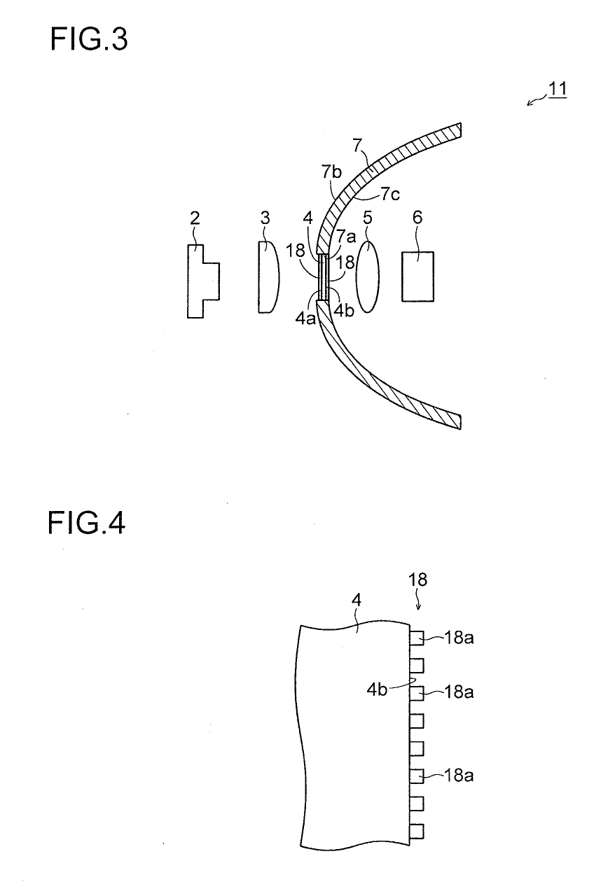

The following description of a second embodiment, which will be given with reference to FIGS. 3 and 4, will deal with a case in which a reflective polarization filter 18 is formed of a wire grid in contrast to the above-described first embodiment.

In a light emitting device 11 according to the second embodiment of the present invention, as shown in FIG. 3, the reflective polarization filter 18 is formed on each of a laser light input surface 4a and a laser light output surface 4b of a light transmitting member 4.

In the second embodiment, the light transmitting member 4 may be formed of a material other than an SiO₂ substrate, such as an SiC substrate, as long as the material transmits light.

The reflective polarization filter 18 may be provided only on either one of the laser light input surface 4a and the laser light output surface 4b of the light transmitting member 4, in the same manner as the reflective polarization filter 8 in the above-described first embodiment.

Also, in the same manner as the reflective polarization filters 8 of the above-described first embodiment, the reflective polarization filters 18 are formed such that they transmit laser light (lineally polarized light) from a semiconductor laser element 2 and reflect linearly polarized light having a polarization plane that is perpendicular to the polarization plane of the laser light. That is, assuming that the laser light outputted from the semiconductor laser element 2 is, for example, a TE wave, the reflective polarization filters 18 are formed to reflect the TM wave component of light from a fluorescent body 6.

Here, in the second embodiment, the reflective polarization filters 18 are each formed of a wire grid. Specifically, as shown in FIG. 4, the reflective polarization filters 18 are each formed of a plurality of fine metal wires 18a made of, for example, Al (aluminum) or the like. The plurality of fine metal wires 18a are, for example, formed to extend in the horizontal direction (in the direction perpendicular to the sheet on which FIG. 4 is drawn). The plurality of fine metal wires 18a are each approximately 100 nm in width and arranged at pitches (for example 200 nm) narrower than the wavelength (for example, approximately 510 nm) of visible light. The plurality of fine metal wires 18a are each formed to have a thickness of, for example, approximately 100 nm.

Incidentally, the plurality of fine metal wires 18a (the wire grid) have a function of transmitting linearly polarized light (e.g., a TE wave) that vibrates in a direction perpendicular to the direction in which the fine metal wires 18a extend (the horizontal direction) and reflecting linearly polarized light (e.g., a TM wave) that vibrates in the direction in which the fine metal wires 18a extends.

In more detail, since the width of each of the fine metal wires 18a is narrow, light (e.g., the TE wave) that vibrates in the direction that is perpendicular to the direction in which the fine metal wires 18a extend is not absorbed by free electrons of the fine metal wires 18a. Thus, the light that vibrates in the direction perpendicular to the direction in which the fine metal wires 18a extend passes through the reflective polarization filters 18. On the other hand, light (e.g., a TM wave) that vibrates in the direction in which the fine metal wires 18a extend is absorbed by the free electrons of the fine metal wires 18a, and the free electrons generate an electromagnetic wave again. As a result, the light that vibrates in the direction in which the fine metal wires 18a extend is reflected by the fine metal wires 18a.

In the second embodiment, the fine metal wires 18a (the reflective polarization filters 18) are formed on the surfaces (the laser light input surface 4a and the laser light output surface 4b) of the light transmitting member 4 by using a publicly known thin film forming method such as a vacuum deposition method and a sputtering method.

Specifically, by using a method such as the vacuum deposition method or the sputtering method, an Al layer (unillustrated) which is approximately 100 nm thick is formed on the surfaces (the laser light input surface 4a and the laser light output surface 4b) of the light transmitting member 4. Then, by using, for example, a photolithography technology, a resist pattern layer (unillustrated) is formed on the Al layer except regions for metal wires 18a. Incidentally, the resist pattern layer is able to be formed by electron beam exposure, nanoprinting, etc.

Thereafter, by using an RIE (reactive ion etching) method or the like, predetermined regions of the Al layer are removed, to thereby form the fine metal wires 18a. Incidentally, other possible methods for forming the fine metal wires 18a include an RIBE (reactive ion beam etching) method and an ICP (inductively coupled plasma) etching method.

In other respects, the structure of the second embodiment is similar to that of the above-described first embodiment.

In the second embodiment, as described above, the reflective polarization filters 18 are formed to transmit the linearly polarized light of the laser light, and reflect the linearly polarized light whose polarization plane is perpendicular to that of the linearly polarized light of the laser light. This makes it possible to improve the light extraction efficiency (light utilization efficiency) as in the first embodiment described above.

Also, in the second embodiment, as described above, the reflective polarization filters 18 are each formed of a wire grid, and thereby the reflective polarization filters 18 can be formed easily.

Other advantages of the second embodiment are similar to the advantages of the above-described first embodiment.

### Third Embodiment

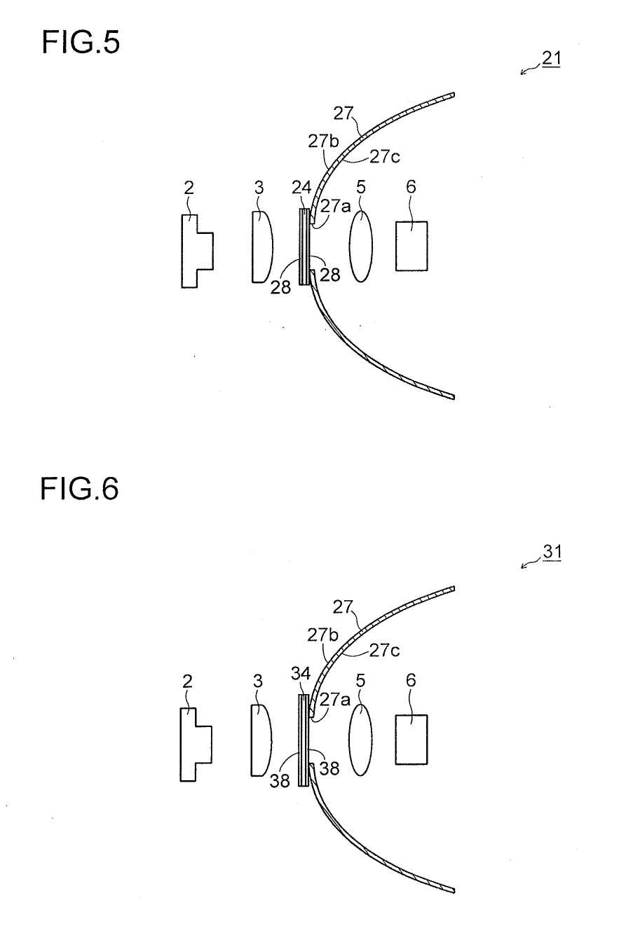

The following description of a third embodiment, which will be given with reference to FIG. 5, will deal with a case in which a light transmitting member 24 and reflective polarization filters 28 are not fitted in an opening 27a of a reflecting mirror 27, in contrast to the above-described first and second embodiments.

In a light emitting device 21 according to the third embodiment of the present invention, as shown in FIG. 5, a light transmitting member 24 and the reflective polarization filters 28 are each formed to have an external size that is larger than the diameter of an opening 27a of a reflecting mirror 27. That is, the light transmitting member 24 and the reflective polarization filters 28 are formed to have an area larger than the opening 27a of the reflecting mirror 27.

And, one of the reflective polarization filters 28 is in contact with an external surface 27b of the reflecting mirror 27 to close the opening 27a from outside (a side opposite to a fluorescent body 6). That is, the front surface of the one of the reflective polarization filters 28 (the outermost surface at the side opposite to the semiconductor laser element 2) does not project inward (toward the side (the fluorescent body 6 side) opposite to the semiconductor laser element 2) from an interior surface 27c of the reflecting mirror 27. Incidentally, the reflecting mirror 27 may be formed to be less thick than the reflecting mirror 7 of the first and second embodiments. The interior surface 27c is an example of the “reflecting surface” of the present invention.

The light transmitting member 24 and the reflective polarization filters 28 may be adhered to the reflecting mirror 27 by using an adhesive (unillustrated) or may be fixed by using a holding member (unillustrated).

The reflective polarization filters 28 of the third embodiment may be formed of a multi-layer film polarizer as in the above-described first embodiment, or may be formed of a wire grid (fine metal wires) as in the above-described second embodiment. In a later-described fourth embodiment and other embodiments which will be described after the fourth embodiment as well, the reflective polarization filter may be formed of a multi-layer film polarizer or may be formed of a wire grid.

In other respects, the structure and production method of the third embodiment are the same as those of the above-described first and second embodiments.

In the third embodiment, as described above, the reflective polarization filters 28 are formed to be larger in area than the opening 27a. This makes it possible to easily restrict the light outputted from the fluorescent body 6 from returning to the semiconductor laser element 2 side after passing through the opening 27a of the reflecting mirror 27. This makes it possible to easily improve the light extraction efficiency. Furthermore, the light transmitting member 24 and the reflective polarization filters 28 do not need to be formed to fit the diameter of the opening 27a, and this helps facilitate the production of the light transmitting member 24 and the reflective polarization filters 28.

In the third embodiment, as described above, the reflective polarization filters 28 are arranged to close the opening 27a from the side opposite to the fluorescent body 6. As a result, in contrast to a case in which the reflective polarization filters 28 arranged to close the opening 27a from the side of the fluorescent body 6, the reflective polarization filters 28 covers no part of the interior surface 27c of the reflecting mirror 27, and this makes it possible to restrict degradation of the light extraction efficiency.

Other advantages of the third embodiment are similar to the advantages of the above-described first and second embodiments.

### Fourth Embodiment

The following description of a fourth embodiment, which will be given with reference to FIGS. 6 to 8, will deal with a case in which part of a light transmitting member 34 has a photonic crystal structure, in contrast to the above-described third embodiment.

In a light emitting device 31 according to the fourth embodiment of the present invention, as shown in FIG. 6, the light transmitting member 34 and reflective polarization filters 38 are each formed to have an external size that is larger than the diameter of an opening 27a of a reflecting mirror 27.

Here, in the fourth embodiment, the light transmitting member 34 and the reflective polarization filters 38 may each have a larger external size than the light transmitting member 24 and the reflective polarization filter 28 of the above-described third embodiment.

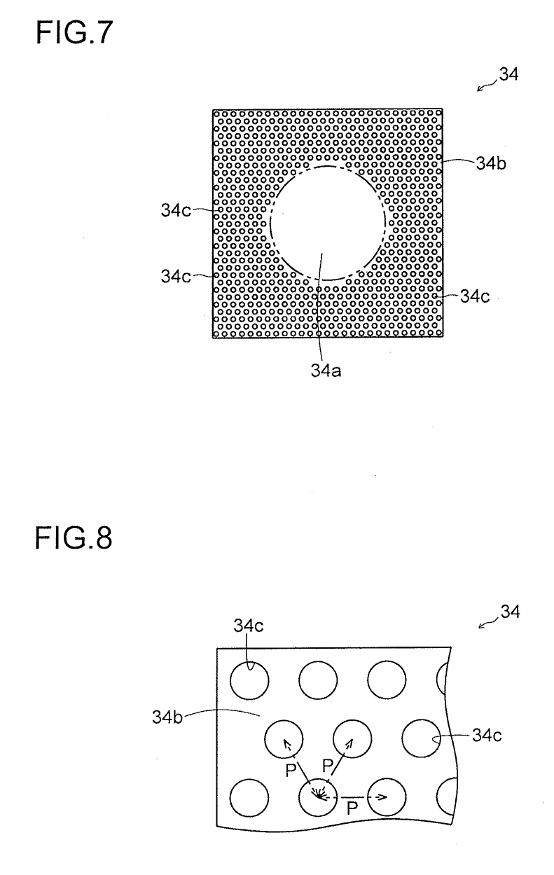

As shown in FIG. 7, the light transmitting member 34 includes a region (a circular region enclosed by an alternative long and two short dashes line) 34a that is arranged to face the opening 27a (see FIG. 6) of the reflecting mirror 27 and a region 34b that surrounds the region 34a. The region 34a is an example of a “first region” of the present invention and the region 34b is an example of a “second region” of the present invention.

And, in the fourth embodiment, the region 34b of the light transmitting member 34 has a two-dimensional photonic crystal structure. This two-dimensional photonic crystal structure is formed to have a photo bandgap that blocks a center wavelength (for example, approximately 510 nm) of visible light from a fluorescent body 6.

Specifically, as shown in FIG. 8, the region 34b of the light transmitting member 34 has a plurality of circular through holes 34c formed therein. The plurality of through holes 34c are arranged in a triangular grid. In addition, the plurality of through holes 34c each have an interior diameter of approximately 100 nm, and are arranged at pitches (cycles) P of approximately 180 nm.

The two-dimensional photonic crystal structure (the plurality of through holes 34c) is formed by using electron beam exposure or a photolithography technique before a multi-layer film polarizer or a wire grid is formed on a surface of the light transmitting member 34.

Specifically, by using electron beam exposure or a photolithography technique, a resist pattern layer (unillustrated) is formed on an SiO₂ substrate (the light transmitting member 34) except regions for the through holes 34c.

Then, by using, for example, an RIE method, an ICP etching method, or an RIBE method, predetermined regions of the SiO₂ substrate are removed, and thereby the light transmitting member 34 having a two-dimensional photonic crystal structure (the plurality of through holes 34c) is formed.

Thereafter, reflective polarization filters 38 are formed on surfaces of the light transmitting member 34, the reflective polarization filters 38 each being formed of a multi-layer film polarizer or a wire grid.

Incidentally, in other respects, the structure and production method of the fourth embodiment are the same as those of the above-described first to third embodiments.

In the fourth embodiment, as described above, in the region 34b of the light transmitting member 34, the two-dimensional photonic crystal structure is formed. This makes it possible to restrict the laser light outputted from the semiconductor laser element 2 and the light outputted from the fluorescent body 6 from entering the region 34b from the region 34a of the light transmitting member 34 after entering the light transmitting member 34. This helps restrict the laser light outputted from the semiconductor laser element 2 and the light outputted from the fluorescent body 6 from leaking through the circumference surface (the side surface) of the light transmitting member 34. As a result, it is possible to further restrict degradation of the light extraction efficiency.

Other advantages of the fourth embodiment are similar to the advantages of the first to third embodiments.

### Fifth Embodiment

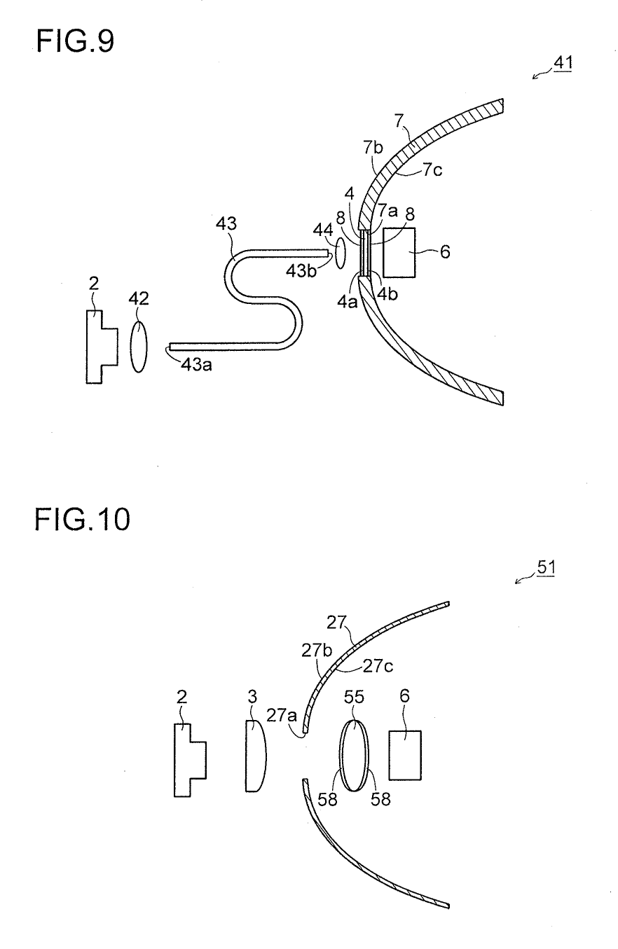

The following description of a fifth embodiment, which will be given with reference to FIG. 9, will deal with a case in which laser light outputted from a semiconductor laser element 2 is guided to a fluorescent body 6 by using a light guide member 43, in contrast to the above-described first to fourth embodiments.

As shown in FIG. 9, a light emitting device 41 according to the fifth embodiment of the present invention includes: a semiconductor laser element 2; a light collecting lens 42 arranged in front of the semiconductor laser element 2; a light guide member 43 arranged in front of the light collecting lens 42; a lens 44 arranged in front of the light guide member 43; a light transmitting member 4 and reflective polarization filters 8 arranged in front of the lens 44; a fluorescent body 6; and a reflecting mirror 7. Incidentally, on surfaces of the light transmitting member 4, reflective polarization filters 18 each formed of a wire grid may be provided instead of the reflective polarization filters 8 which are each formed of a multi-layer film polarizer.

The light collecting lens 42 is formed of a biconvex lens, for example, and has a function of collecting laser light from the semiconductor laser element 2 to make the laser light enter the light guide member 43.

The light guide member 43 is formed of, for example, an optical fiber having a diameter of approximately 0.1 mm to approximately 3.0 mm. Thus, by forming the light guide member 43 of an optical fiber, it is possible to increase the degree of freedom of the position arrangement of the semiconductor laser element 2. In addition, since it is also possible to attach the semiconductor laser element 2 to an existing heat dissipating member, there is no need of additionally providing a heat dissipating member for dissipating heat generated in the semiconductor laser element 2.

Furthermore, the light guide member 43 includes a laser light input surface 43a that is arranged at the semiconductor laser element 2 side (the light collecting lens 42 side) and a laser light output surface 43b that is arranged at the fluorescent body 6 side (the lens 44 side).

The laser light input surface 43a (an end portion of the light guide member 43 at the semiconductor laser element 2 side), the light collecting lens 42, and the semiconductor laser element 2 are arranged in line. The laser light output surface 43b (an end portion of the light guide member 43 at the fluorescent body 6 side), the lens 44, the light transmitting member 4, the reflective polarization filters 8, and the fluorescent body 6 are arranged in line.

The light guide member 43 has a function of guiding laser light coming therein to the lens 44 while totally reflecting the laser light.

In the fifth embodiment, the light guide member 43 is formed of a polarization maintaining fiber, and the laser light from the semiconductor laser element 2 is guided to the lens 44 with its polarization plane maintained.

The lens 44 is formed of a biconvex lens, for example, and has a function of collecting the laser light from the light guide member 43 to make the laser light enter the light transmitting member 4 and the reflective polarization filters 8. The lens 44 may be formed to convert the laser light from the light guide member 43 into parallel light, for example, instead of collecting the laser light from the light guide member 43. In a case in which the distance from the light guide member 43 to the fluorescent body 6 is sufficiently small or in a case in which the fluorescent body 6 is sufficiently large, it is possible to irradiate all the laser light outputted from the light guide member 43 onto the fluorescent body 6, and thus the lens 44 does not need to be provided.

Angle adjustment is performed with respect to the semiconductor laser element 2 (or the light guide member 43) and the reflective polarization filters 8 such that the reflective polarization filters 8 transmit laser light (linearly polarized light) that has passed through the light guide member 43 and reflect linearly polarized light whose polarization plane is perpendicular to that of the laser light.

In other respects, the structure and production method of the fifth embodiment are the same as those of the above-described first to fourth embodiments.

Other advantages of the fifth embodiment are similar to the advantages of the first to fourth embodiments described above.

### Sixth Embodiment

The following description of a sixth embodiment, which will be given with reference to FIG. 10, will deal with a case in which reflective polarization filters 58 are formed on surfaces of a lens 55, in contrast to the above-described first to fifth embodiments.

In a light emitting device 51 according to the sixth embodiment of the present invention, as shown in FIG. 10, no light transmitting member is provided, and the reflective polarization filters 58 are formed on surfaces (a laser light input surface and a laser light output surface) of the lens 55. That is, in the sixth embodiment, an opening 27a of a reflecting mirror 27 is not closed by a light transmitting member or by the reflective polarization filters 58. Incidentally, the lens 55 is structured in a manner similar to the lens 5 of the above-described first embodiment. The lens 55 is an example of an “optical member” of the present invention.

In other respects, the structure and production method of the fourth embodiment are the same as those of the above-described first to fifth embodiments.

In the sixth embodiment, as described above, the reflective polarization filters 58 are formed on the surfaces of the lens 55. With this structure, it is possible to form the reflective polarization filters 58 and the lens 55 as a single piece, and this helps reduce the size and weight of the light emitting device 51.

Other advantages of the sixth embodiment are similar to the advantages of the above-described first to fifth embodiments.

### Seventh Embodiment

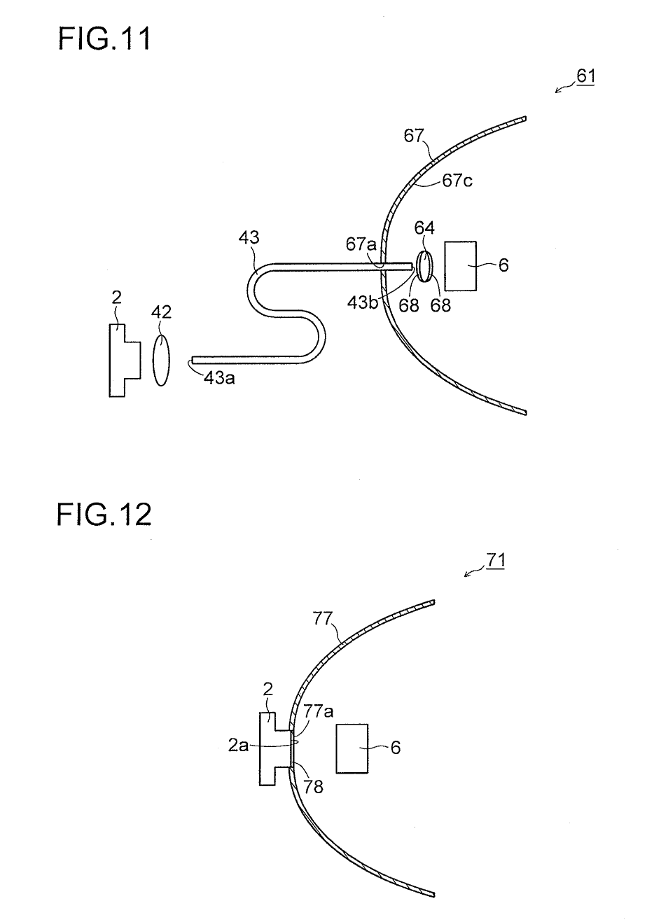

The following description of a seventh embodiment, which will be given with reference to FIG. 11, will deal with a case in which laser light outputted from a semiconductor laser element 2 is guided to a fluorescent body 6 by using a light guide member 43, in contrast to the above-described sixth embodiment.

As shown in FIG. 11, a light emitting device 61 according to a seventh embodiment of the present invention includes: the semiconductor laser element 2; the light guide member 43; a lens 64; reflective polarization filters 68; a fluorescent body 6; and a reflecting mirror 67. The lens 64 is an example of the “optical member” of the present invention.

An opening 67a of the reflecting mirror 67 has an interior diameter that is equal to or slightly larger than the diameter of the light guide member 43.

And, in the seventh embodiment, an end portion of the light guide member 43 at the fluorescent body 6 side is fitted in the opening 67a of the reflecting mirror 67. That is, a laser light output surface 43b of the light guide member 43 is arranged inward from an interior surface 67c of the reflecting mirror 67 (that is, at a side (the fluorescent body 6 side) opposite to the semiconductor laser element 2).

The lens 64 is structured in a manner similar to the lens 44 of the above-described fifth embodiment. Also, the lens 64 has a diameter that is larger than the diameter of the light guide member 43 but smaller than the diameter of the lens 55 of the above-described sixth embodiment.

In the seventh embodiment, as in the above-described sixth embodiment, no light guide member is provided, and the reflective polarization filters 68 are formed on surfaces (a laser light input surface and a laser light output surface) of the lens 64.

Incidentally, in the seventh embodiment, in which the lens 64 is provided between the light guide member 43 and the fluorescent body 6, if there is no need of collecting laser light outputted from the light guide member 43, a plate-shaped light transmitting member, for example, may be provided instead of the lens 64.

In other respects, the structure and production method of the seventh embodiment are the same as those of the above-described fifth and sixth embodiments.

In the seventh embodiment, as described above, the opening 67a is formed in the reflecting mirror 67 for laser light outputted from the semiconductor laser element 2 to pass through, and the light guide member 43 is fitted in the opening 67a. With this structure, it is possible to restrict increase in size of the opening 67a, and thus to further restrict the light from the fluorescent body 6 from returning to the semiconductor laser element 2 side through the opening 67a.

Other advantages of the second embodiment are similar to the advantages of the above-described first to sixth embodiments.

### Eighth Embodiment

The following description of an eighth embodiment, which will be given with reference to FIG. 12, will deal with a case in which a reflective polarization filter 78 is formed on a surface of a semiconductor laser element 2, in contrast to the above-described first to seventh embodiments.

A light emitting device 71 of the eighth embodiment of the present invention includes, as shown in FIG. 12, the semiconductor laser element 2, the reflective polarization filter 78, a fluorescent body 6, and a reflecting mirror 77.

Here, in the eighth embodiment, the reflective polarization filter 78 formed of a wire grid, for example, is formed on a laser light output surface (a front surface) 2a of the semiconductor laser element 2. Incidentally, a reflective polarization filter 78 may be formed of a multi-layer film polarizer. The laser light output surface 2a is an example of a “third laser light output surface” of the present invention.

The laser light output surface 2a of the semiconductor laser element 2 and the reflective polarization filter 78 are formed to have a same diameter (a same external size).

An opening 77a of the reflecting mirror 77 has an interior diameter (an interior size) that is equal to or slightly smaller than the diameter (the external size) of the laser light output surface 2a of the semiconductor laser element 2 and the reflective polarization filter 78.

And, the semiconductor laser element 2 and the reflective polarization filter 78 are fitted and fixed in the opening 77a of the reflecting mirror 77, and thus close the opening 77a.

Incidentally, in other respects, the structure and production method of the eighth embodiment are the same as those of the above-described first to seventh embodiments.

According to the eighth embodiment, as described above, by forming the reflective polarization filter 78 on the laser light output surface 2a of the semiconductor laser element 2, it is possible to form the reflective polarization filter 78 and the semiconductor laser element 2 as one piece, and this helps reduce the size and weight of the light emitting device 71. Furthermore, angle adjustment does not need to be performed, in assembling the light emitting device 71, with respect to the semiconductor laser element 2 and the reflective polarization filter 78 such that the reflective polarization filter 78 transmits the linearly polarized light of the laser light outputted from the semiconductor laser element 2. This makes it possible to simplify the assembly procedure of the light emitting device 71.

Further, other advantages of the eighth embodiment are similar to those of the above-described first to seventh embodiments.

### Ninth Embodiment

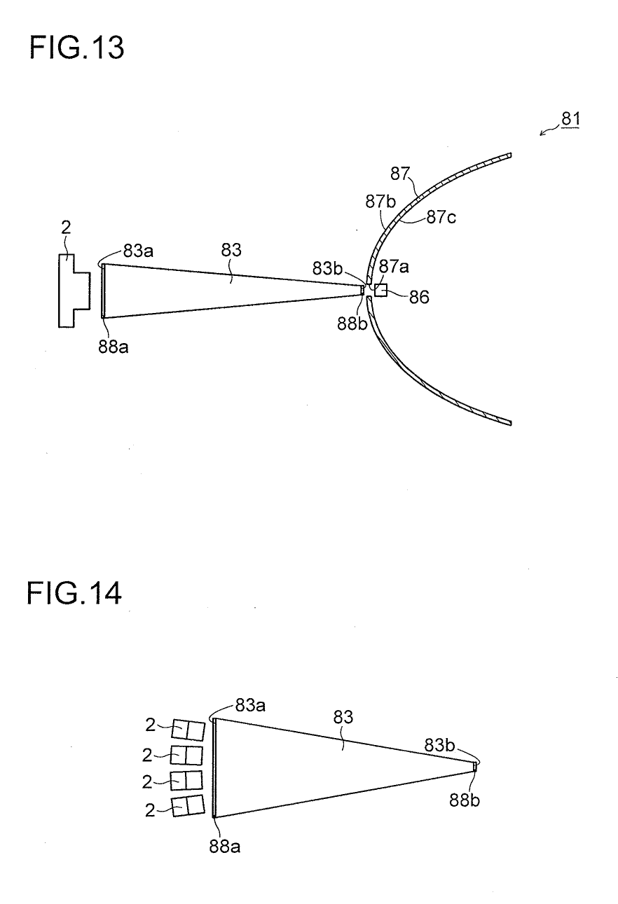

The following description of a ninth embodiment, which will be given with reference to FIGS. 13 and 14, will deal with a case in which a light guide member 83 having a light collecting function is used, in contrast to the above-described first to eighth embodiments.

As shown in FIG. 13, a light emitting device 81 according to the ninth embodiment of the present invention includes: a plurality of semiconductor laser elements 2 (see FIG. 14); the light guide member 83; reflective polarization filters 88a and 88b; a fluorescent body 86; and a reflecting mirror 87. Incidentally, the light guide member 83 is an example of the “optical member” of the present invention.

The light guide member 83 is formed of a material that transmits light, and has a light collecting function.

Specifically, as shown in FIGS. 13 and 14, the light guide member 83 is formed in a shape of, for example, a truncated quadrangular pyramid, and includes a laser light input surface 83a and a laser light output surface 83b which is smaller in area than the laser light input surface 83a. Incidentally, the laser light output surface 83b is an example of a “first laser light output surface” and a “second laser light output surface” of the present invention.

Also, the laser light output surface 83b is formed such that lengths thereof in up-down and horizontal directions are smaller than the interior diameter of the opening 87a of the reflecting mirror 87, and such that the laser light output surface 83b is present within the range of the opening 87a of the reflecting mirror 87 when it is seen from the semiconductor laser element 2 side (or from the fluorescent body 86 side).

In the ninth embodiment, as shown in FIG. 14, a plurality of (for example, four) semiconductor laser elements 2 are arranged to face the laser light input surface 83a of the light guide member 83. These semiconductor laser elements 2 are arranged such that extension lines drawn from resonators (unillustrated) of the semiconductor laser elements 2 would converge substantially to one point. And, light outputted from the plurality of semiconductor laser elements 2 enters the light guide member 83 where the light is totally reflected on surface portion of the light guide member 83, to be collected to the laser light output surface 83b. Incidentally, since the shape of the light guide member 83 makes it possible to collect the laser light outputted from the plurality of the semiconductor laser elements 2 to the laser light output surface 83b, it is not essential to arrange the plurality of semiconductor laser elements 2 such that extension lines drawn from the resonators (unillustrated) of the semiconductor laser elements 2 would converge substantially to one point. That is, the plurality of semiconductor laser elements 2 may be arranged, for example, such that the resonators (unillustrated) are parallel to one another.

Also, in the ninth embodiment, the reflective polarization filter 88a is formed on the laser light input surface 83a of the light guide member 83, and the reflective polarization filter 88b is formed on the laser light output surface 83b.

The fluorescent body 86 is arranged inward from an interior surface 87c of the reflecting mirror 87 (that is, at a side opposite to the semiconductor laser elements 2). Incidentally, the interior surface 87c is an example of the “reflecting surface” of the present invention.

In other respects, the structure and production method of the ninth embodiment are the same as those of the above-described first to eighth embodiments.

In the ninth embodiment, as described above, it is possible to collect laser light that passes inside the light guide member 83 by providing the light guide member 83 with the laser light input surface 83a and the laser light output surface 83b having a smaller area than the laser light input surface 83a. This makes it possible to collect laser light outputted from the plurality of laser elements 2 by using the light guide member 83 and irradiate the laser light onto the single fluorescent body 86. As a result, it is possible to restrict increase of the number of fluorescent bodies even in the case in which the plurality of semiconductor laser elements 2 are used, and this makes it possible to further reduce the size and weight of the light emitting device 81.

Also, in the ninth embodiment, as described above, the reflective polarization filters 88a and 88b are formed on the laser light input surface 83a and the laser light output surface 83b of the light guide member 83. With this structure, it is possible to form the reflective polarization filter 88a, the reflective polarization filter 88b, and the light guide member 83 as one piece, and this helps further reduce the size and weight of the light emitting device 81.

Further, other advantages of the ninth embodiment are similar to the advantages of the above-described first to eighth embodiments.

The embodiments disclosed herein are to be considered in all respects as illustrative and not restrictive. The scope of the present invention is set out in the appended claims and not in the description of the embodiments hereinabove, and includes any variations and modifications within the sense and scope equivalent to those of the claims.

For example, light emitting devices according to the present invention are applicable to indicator lamps (indicating lights), illuminations lamps (bulbs), projectors or laser pointers, and other various types of light emitting devices. The light emitting devices of the present invention are also applicable to head lamps for mobile bodies such as automobiles (vehicles), backlights for display devices, room illumination devices, searchlights or illumination devices for endoscopes, and other various types of illumination devices.

Further, the above-described embodiments have dealt with cases in which laser light is converted to visible light, but this is not meant to limit the present invention, and the laser light may be converted to light other than visible light. For example, in a case in which laser light is converted to infrared light, the light emitting devices of the present invention are also applicable to nighttime illumination devices of CCD cameras for security monitoring, infrared light emitting devices of infrared heaters, and the like.

Also, the above-described embodiments have dealt with cases in which a semiconductor laser element is used as a laser generator, but this is not meant to limit the present invention, and laser generators other than semiconductor laser elements may be used.

Further, although the above-described embodiments have dealt with cases in which a semiconductor laser element that outputs blue-violet laser light and a fluorescent body that converts the laser light to visible light including blue light, green light, and red light and outputs the resulting visible light are provided, the blue light, the green light and the red light being mixed to be outputted as white light; this is not meant to limit the present invention, and, for example, a semiconductor laser element that emits blue laser light and a fluorescent body that converts part of the blue laser light to yellow light and outputs the resulting yellow light, or, there may be provided a semiconductor laser element and a fluorescent body that output other colors. Also, a semiconductor laser element and a fluorescent body may be formed such that light of a color other than white is outputted.

Further, the above-described embodiments have dealt with cases in which a reflective polarization filter is formed of a multi-layer film polarizer or a wire grid, but this is not meant to limit the present invention, and a reflective polarization filter may be formed otherwise.

Also, the above-described first embodiment, for example, has dealt with a case in which a multi-layer film polarizer is formed by using CaCO₃ and SiO₂, but this is not meant to limit the present invention, and a multi-layer film polarizer may be formed of a material other than CaCO₃ and SiO₂, such as alumina and polymer.

Also, the above-described first embodiment, for example, has dealt with a case in which fifty CaCo₃ layers and fifty SiO₂ layers are alternately laid one over another to form a multi-layer film polarizer, but this is not meant as a limitation to the present invention, and the numbers of the CaCo₃ layers and fifty SiO₂ layers can be set to any number.

Also, the above-described second embodiment, for example, has dealt with a case in which a wire grid (fine metal wires) is made of Al, but this is not meant to limit the present invention, and a wire grid may be made of another metal material such as stainless steel, Au, Ag, or Cu.

Also, the above-described third embodiment, for example, has dealt with a case in which a light transmitting member and a reflective polarization filter are arranged to close an opening of a reflecting mirror from outside, but this is not meant to limit the present invention, and a light transmitting member and a reflective polarization filter may be arranged to close an opening of a reflecting mirror from inside (a fluorescent body side).

The above-described fourth embodiment has dealt with a case in which through holes are formed in an SiO₂ substrate (a light transmitting member) to form a photonic crystal structure, but this is not meant to limit the present invention, and non-through holes may be formed in the SiO₂ substrate (the light transmitting member) if it allows the SiO₂ substrate (the light transmitting member) to fulfill a desired function.

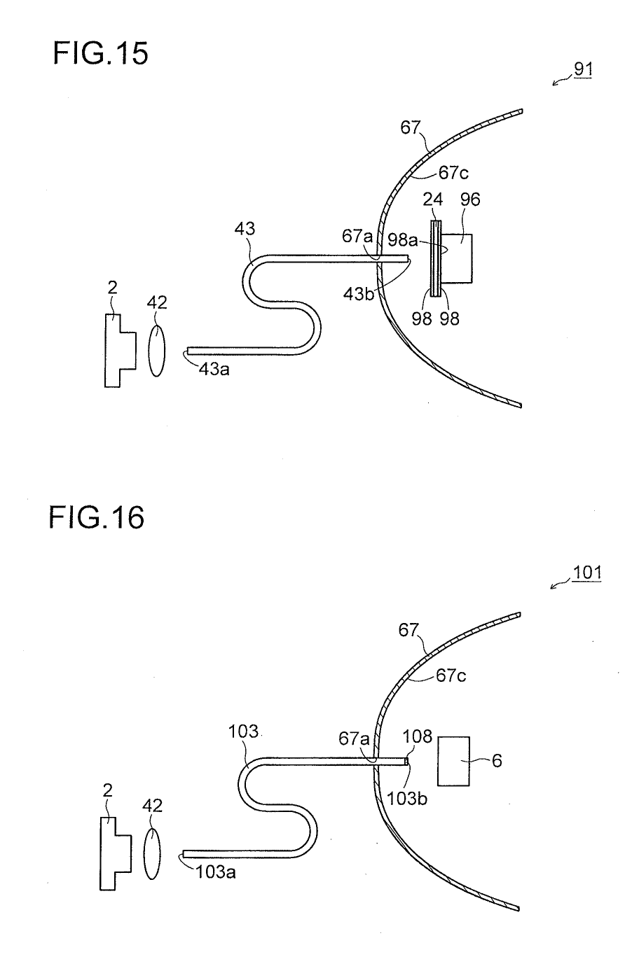

Also, the above-described embodiments have dealt with cases in which a fluorescent body is arranged a predetermined distance away from a reflective polarization filter, but this is not meant to limit the present invention; as shown in a light emitting device 91 according to a first modified example of the present invention shown in FIG. 15, a fluorescent body 96 may be joined (adhered) to a laser light output surface (a fourth laser light output surface) 98a of a reflective polarization filter 98, to form the reflective polarization filter 98 and the fluorescent body 96 as one piece.

Also, the above-described fifth and seventh embodiments have dealt with cases in which no reflective polarization filter is formed on a surface of a light guide member formed of an optical fiber, but this is not meant to limit the present invention; as in a light emitting device 101 according to a second modified example of the present invention shown in FIG. 16, a reflective polarization filter 108 may be integrally formed on a laser light output surface (a first laser light output surface) 103b of a light guide member (an optical member) 103 formed of an optical fiber. Alternatively, the reflective polarization filter 108 may be integrally formed on a laser light input surface 103a of the light guide member 103. Incidentally, in a case in which the reflective polarization filter 108 is formed on the surface (the laser light input surface 103a or the laser light output surface 103b) of the light guide member 103 formed of an optical fiber, the reflective polarization filter 108 may be formed of, for example, a multi-layer film polarizer.

Also, the above-described ninth embodiment, for example, has dealt with a case in which a plurality of semiconductor laser elements and a light guide member having a light collecting function are provided, but this is not meant to limit the present invention; a light guide member having a light collecting function may be provided even in a case in which a single semiconductor laser element is provided. In this case as well, by collecting laser light, it is possible to reduce the size of a fluorescent body, and thus to reduce the size and weight of the light emitting device.

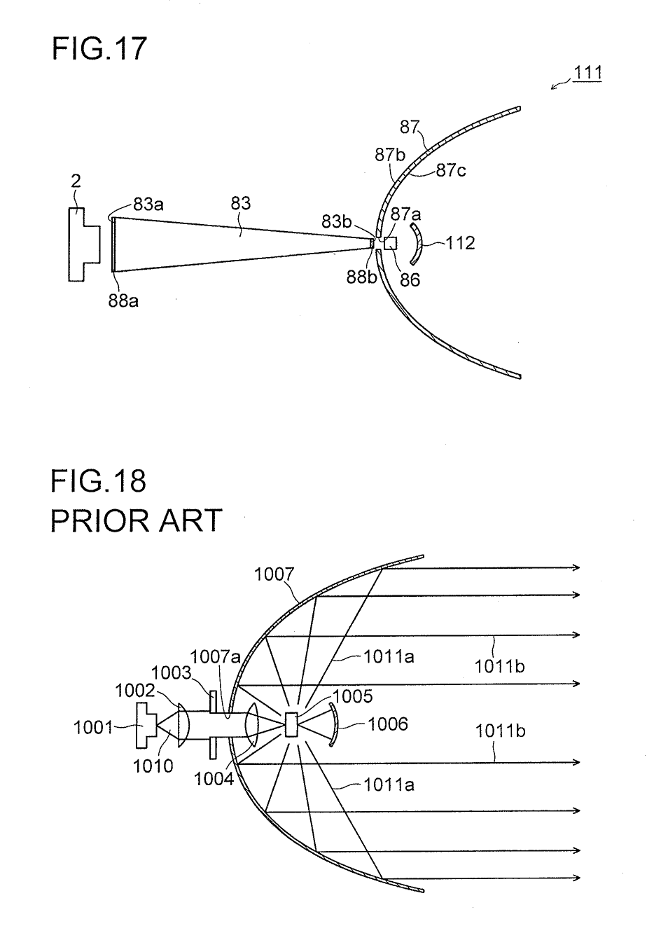

Also, the above-described embodiments have dealt with cases in which no reflecting mirror is provided in front of a fluorescent body, but this is not meant to limit the present invention; as in a light emitting device 111 according to a third modified example of the present invention shown in FIG. 17, a reflecting mirror 112 may be provided in front of a fluorescent body 86. In this case, the reflecting mirror 112 may be structured to reflect light coming from a fluorescent body 86 back to the fluorescent body 86. With this structure, light outputted from the fluorescent body 86 is never outputted as it is from the light emitting device 111. That is, the light outputted from the fluorescent body 86 is once reflected by a reflecting mirror 87 and then outputted from the light emitting device 111, and this makes it possible to control the irradiation range of the light emitting device 111.

Further, in a case in which the thickness of the fluorescent body 86 is small, it is possible that part of laser light may pass through the fluorescent body 86 without undergoing conversion by the fluorescent body 86; however, by providing the reflecting mirror 112 in front of the fluorescent body 86, it is possible to make laser light that has passed through the fluorescent body 86 reenter the fluorescent body 86 to be converted to visible light.

What is claimed is:

1. A light emitting device, comprising:
a laser generator which outputs linearly polarized laser light;
a fluorescent body which is irradiated with the laser light from the laser generator; and
a reflective polarization filter which is arranged in a region through which the laser light outputted from the laser generator passes,
wherein
the reflective polarization filter is formed to transmit linearly polarized light of the laser light and reflect linearly polarized light having a polarization plane which is perpendicular to a polarization plane of the linearly polarized light of the laser light.

2. The light emitting device of claim 1, further comprising: a reflecting mirror which reflects light coming from the fluorescent body in a predetermined direction.

3. The light emitting device of claim 2,
wherein
the reflecting mirror includes an opening through which the laser light outputted from the laser generator passes; and
the reflective polarization filter is arranged to close the opening.

4. The light emitting device of claim 2,
wherein
a surface of the reflective polarization filter at the fluorescent body side is arranged so as not to project from a reflecting surface of the reflecting mirror toward the fluorescent body side.

5. The light emitting device of claim 2,
wherein
the reflecting mirror includes an opening through which the laser light outputted from the laser generator passes; and
the reflective polarization filter has an area larger than the opening.

6. The light emitting device of claim 5,
wherein
the reflective polarization filter is arranged to close the opening from a side opposite to the fluorescent body.

7. The light emitting device of claim 5,
wherein
the reflective polarization filter includes a first region which is arranged to face the opening and a second region which surrounds the first region; and
the second region has a photonic crystal structure.

8. The light emitting device of claim 1, further comprising:
an optical member which is arranged in the region through which the laser light outputted from the laser generator passes,
wherein
the reflective polarization filter is formed on a surface of the optical member.

9. The light emitting device of claim 8,
wherein
the optical member includes at least either one of a light guide member and a lens.

10. The light emitting device of claim 9,
wherein
the optical member includes a light guide member having a laser light input surface and a first laser light output surface; and
the reflective polarization filter is formed on at least either one of the laser light input surface and the first laser light output surface of the light guide member.

11. The light emitting device of claim 9, wherein
the optical member includes the light guide member and the lens which is arranged between the light guide member and the fluorescent body; and
the reflective polarization filter is formed on a surface of the lens.

12. The light emitting device of claim 1, further comprising:
a light guide member which is arranged in the region through which the laser light outputted from the laser generator passes,
wherein
the light guide member includes a laser light input surface and a second laser light output surface having an area smaller than the laser light input surface.

13. The light emitting device of claim 1, wherein the reflective polarization filter is formed on a third laser light output surface of the laser generator.

14. The light emitting device of claim 1, wherein the fluorescent body is provided on a fourth laser light output surface of the reflective polarization filter.

15. The light emitting device of claim 1, further comprising:
a reflecting mirror which reflects light coming from the fluorescent body in a predetermined direction; and
a light guide member which is arranged in the region through which the laser light outputted from the laser generator passes,
wherein
the reflecting mirror includes an opening through which the laser light outputted from the laser generator passes; and
the light guide member is fitted in the opening of the reflecting mirror.

16. The light emitting device of claim 1, wherein the laser generator includes a semiconductor laser element.

17. The light emitting device of claim 1, wherein the reflective polarization filter includes a multi-layer film polarizer.

18. The light emitting device of claim 1, wherein the reflective polarization filter includes a wire grid.

19. An illumination device, comprising: the light emitting device of claim 1.
